(19) United States
(12) Patent Application Publication
(10) Pub. No.: US 2013/0114692 A1
(43) Pub. Date: May 9, 2013

(54) Simplified Coefficient Scans for Non-Square Transforms (NSQT) in Video Coding

(71) Applicant: Texas Instruments Incorporated, Dallas, TX (US)

(72) Inventors: Vivienne Sze, Dallas, TX (US); Madhukar Budagavi, Plano, TX (US)

(73) Assignee: TEXAS INSTRUMENTS INCORPORATED, Dallas, TX (US)

(21) Appl. No.: 13/665,587

(22) Filed: Oct. 31, 2012

Related U.S. Application Data
(60) Provisional application No. 61/555,693, filed on Nov. 4, 2011.
(60) Provisional application No. 61/557,007, filed on Nov. 8, 2011.
(60) Provisional application No. 61/559,958, filed on Nov. 15, 2011.
(60) Provisional application No. 61/562,217, filed on Nov. 21, 2011.
(60) Provisional application No. 61/564,111, filed on Nov. 28, 2011.
(60) Provisional application No. 61/583,315, filed on Jan. 5, 2012.

(51) Int. Cl. H04N 7/30; H04N 7/32

(52) U.S. Cl. 375/240.03; 375/E07.226; 375/E07.211

(57) ABSTRACT

A method for encoding a video sequence is provided that includes applying a non-square transform to a non-square block of residual values to generate a non-square block of transform coefficients, quantizing the transform coefficients to generate a non-square block of quantized transform coefficients, dividing the non-square block of quantized transform coefficients into a plurality of square blocks of quantized transform coefficients, and entropy encoding the plurality of square coefficient blocks.

### CROSS-REFERENCE TO RELATED APPLICATIONS

This application claims benefit of U.S. Provisional Patent Application Ser. No. 61/555,693 filed Nov. 4, 2011, U.S. Provisional Patent Application Ser. No. 61/557,007 filed Nov. 8, 2011, U.S. Provisional Patent Application Ser. No. 61/559,958 filed Nov. 15, 2011, U.S. Provisional Patent Application Ser. No. 61/562,217 filed Nov. 21, 2011, U.S. Provisional Patent Application Ser. No. 61/564,111 filed Nov. 28, 2011, and U.S. Provisional Patent Application Ser. No. 61/583,315 filed Jan. 5, 2012, all of which are incorporated herein by reference in their entirety.

### BACKGROUND OF THE INVENTION

1. Field of the Invention

Embodiments of the present invention generally relate to simplified coefficient scans for non-square transforms (NSQT) in video coding.

2. Description of the Related Art

The Joint Collaborative Team on Video Coding (JCT-VC) of ITU-T WP3/16 and ISO/IEC JTC 1/SC 29/WG 11 is currently developing the next-generation video coding standard referred to as High Efficiency Video Coding (HEVC). Similar to previous video coding standards such as H.264/AVC, HEVC is based on a hybrid coding scheme using block-based prediction and transform coding. First, the input signal is split into rectangular blocks that are predicted from the previously decoded data by either motion compensated (inter) prediction or intra prediction. The resulting prediction error (i.e., residual) is coded by applying block transforms based on an integer approximation of the discrete cosine transform, which is followed by quantization. The energy compaction properties of the transform (along with quantization) enable the residual to be represented by few coefficients in the transform/frequencies domain rather than many pixels in the spatial domain. The resulting two dimensional (2D) array of quantized coefficients is scanned into a 1-D array and the coefficients are then compressed into fewer bits by entropy coding.

In previous video coding standards such as H.264/AVC, square transforms (SQT) were used in which the vertical and horizontal size of a transform was the same. In HEVC, in addition to SQTs, non-square transforms (NSQT) have been proposed for use on non-square prediction units.

### SUMMARY

Embodiments of the present invention relate to methods, apparatus, and computer readable media for simplified scanning of coefficients in non-square transform blocks. In one aspect, a method for encoding a video sequence is provided that includes applying a non-square transform to a non-square block of residual values to generate a non-square block of transform coefficients, quantizing the transform coefficients to generate a non-square block of quantized transform coefficients, dividing the non-square block of quantized transform coefficients into a plurality of square blocks of quantized transform coefficients, and entropy encoding the plurality of square coefficient blocks.

In one aspect, a method for decoding a compressed video bit stream is provided that includes entropy decoding a plurality of quantized transform coefficients corresponding to an encoded non-square block of quantized transform coefficients, mapping the quantized transform coefficients to a plurality of square blocks, mapping the quantized transform coefficients in the plurality of square blocks to a non-square block to recreate the non-square block of quantized transform coefficients, dequantizing the quantized transform coefficients to generate a non-square block of transform coefficients, and applying an inverse non-square transform to the non-square block of transform coefficients to generate a non-square block of residual values.

### BRIEF DESCRIPTION OF THE DRAWINGS

Particular embodiments will now be described, by way of example only, and with reference to the accompanying drawings:

FIG. 1 is an example of quadtree based largest coding unit (LCU) decomposition;

FIG. 2 illustrates the encoding flow for square transform blocks;

FIG. 3 illustrates the decoding flow for square transform blocks;

FIG. 4 illustrates the encoding flow for non-square transform blocks;

FIG. 5 illustrates the decoding flow for non-square transform blocks;

FIG. 6 is a block diagram of a digital system;

FIG. 7 is a block diagram of a video encoder;

FIG. 8 illustrates entropy encoding flow in the video encoder of FIG. 7;

FIG. 9 is a block diagram of a video decoder;

FIG. 10 illustrates entropy decoding flow in the video decoder of FIG. 9;

FIGS. 11 and 14 are flow diagrams of methods;

FIGS. 12A-12C and 13 are examples; and

FIG. 15 is a block diagram of an illustrative digital system.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

As used herein, the term “picture” may refer to a frame or a field of a frame. A frame is a complete image captured during a known time interval. For convenience of description, embodiments of the invention are described herein in reference to HEVC. One of ordinary skill in the art will understand that embodiments of the invention are not limited to HEVC.

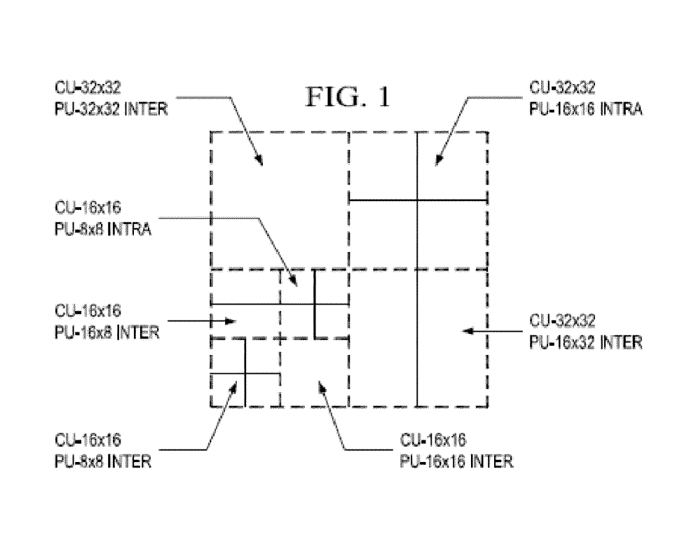

In HEVC, a largest coding unit (LCU) is the base unit used for block-based coding. A picture is divided into non-overlapping LCUs. That is, an LCU plays a similar role in coding as the macroblock of H.264/AVC, but it may be larger, e.g., 32×32, 64×64, etc. An LCU may be partitioned into coding units (CU). A CU is a block of pixels within an LCU and the CUs within an LCU may be of different sizes. The partitioning is a recursive quadtree partitioning. The quadtree is split according to various criteria until a leaf is reached, which is referred to as the coding node or coding unit. The maximum hierarchical depth of the quadtree is determined by the size of the smallest CU (SCU) permitted. The coding node is the root node of two trees, a prediction tree and a transform tree. A prediction tree specifies the position and size of prediction units (PU) for a coding unit. A transform tree specifies the position and size of transform units (TU) for a coding unit. A transform unit may not be larger than a coding unit and the size of a square transform unit may be, for example, 4×4, 8×8, 16×16, and 32×32. The sizes of the transforms units and prediction units for a CU are determined by the video encoder during prediction based on minimization of rate/distortion costs. FIG. 1 shows an example of a quadtree based LCU to CU/PU decomposition structure in which the size of the SCU is 16×16 and the size of the LCU is 64×64.

Various versions of HEVC are described in the following documents, which are incorporated by reference herein: T. Wiegand, et al., “WD3: Working Draft 3 of High-Efficiency Video Coding,” JCTVC-E603, Joint Collaborative Team on Video Coding (JCT-VC) of ITU-T SG16 WP3 and ISO/IEC JTC1/SC29/WG11, Geneva, CH, Mar. 16-23, 2011 (“WD3”), B. Bross, et al., “WD4: Working Draft 4 of High-Efficiency Video Coding,” JCTVC-F803_d6, Joint Collaborative Team on Video Coding (JCT-VC) of ITU-T SG16 WP3 and ISO/IEC JTC1/SC29/WG11, Torino, IT, Jul. 14-22, 2011 (“WD4”), B. Bross. et al., “WD5: Working Draft 5 of High-Efficiency Video Coding,” JCTVC-G1103_d9, Joint Collaborative Team on Video Coding (JCT-VC) of ITU-T SG16 WP3 and ISO/IEC JTC1/SC29/WG11, Geneva, CH, Nov. 21-30, 2011 (“WD5”), B. Bross, et al., “High Efficiency Video Coding (HEVC) Text Specification Draft 6,” JCTVC-H1003, Joint Collaborative Team on Video Coding (JCT-VC) of ITU-T SG16 WP3 and ISO/IEC JTC1/SC29/WG1, Geneva, CH, Nov. 21-30, 2011 (“HEVC Draft 6”), B. Bross, et al., “High Efficiency Video Coding (HEVC) Text Specification Draft 7,” JCTVC-11003_d0, Joint Collaborative Team on Video Coding (JCT-VC) of ITU-T SG16 WP3 and ISO/IEC JTC1/SC29/WG1, Geneva, CH, Apr. 17-May 7, 2012 (“HEVC Draft 7”), and B. Bross, et al., “High Efficiency Video Coding (HEVC) Text Specification Draft 8,” JCTVC-J1003_d7, Joint Collaborative Team on Video Coding (JCT-VC) of ITU-T SG16 WP3 and ISO/IEC JTC1/SC29/WG1, Stockholm, SE, Jul. 11-20, 2012 (“HEVC Draft 8”).

Some aspects of this disclosure have been presented to the JCT-VC in V. Sze, “Non-CE11: Simplified Coefficient Scans for NSQT,” JCTVC-G123, Joint Collaborative Team on Video Coding (JCT-VC) of ITU-T SG16 WP3 and ISO/IEC JTC1/SC29/WG11, Geneva, CH, Nov. 21-30, 2011, which is incorporated by reference herein in its entirety.

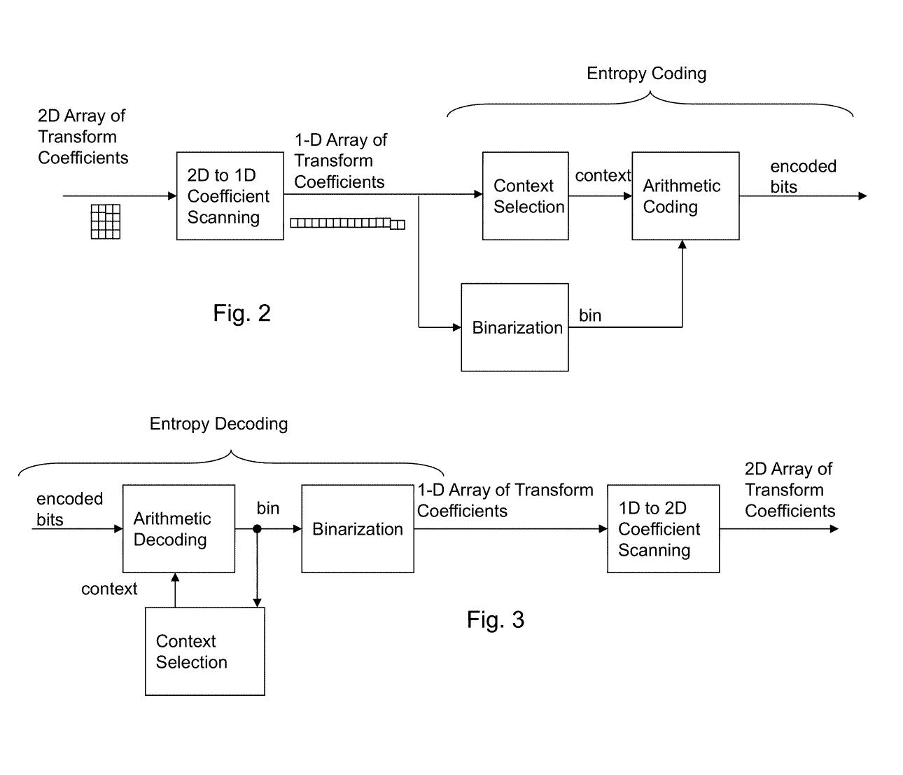

As was previously mentioned, in video encoding, transforms are applied to blocks of residual video data to reduce the size of the data to a small number of coefficients in the transform domain. The resulting two dimensional (2D) array of coefficients (after quantization) is scanned into a one dimensional (1D) array for entropy coding which further compresses the quantized coefficients into a compressed bit stream. FIG. 2 illustrates this encoding data flow for square transform blocks. For video decoding, the compressed bit stream is entropy decoded to recover the 1D array of transform coefficients. The 1D array of transform coefficients is then scanned into a 2D array of coefficients for dequantization and application of the inverse transform. FIG. 3 illustrates this decoding data flow for square transform blocks.

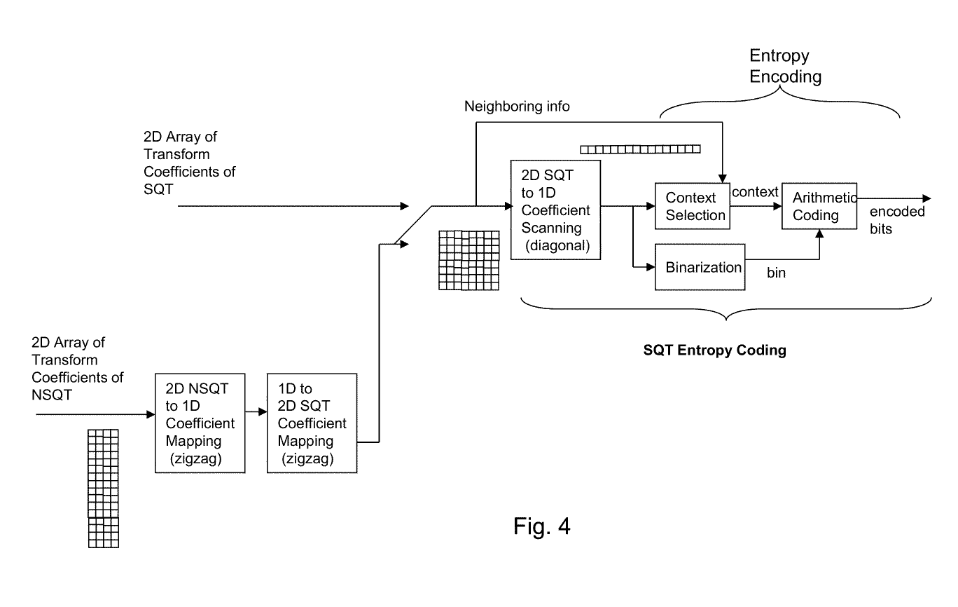

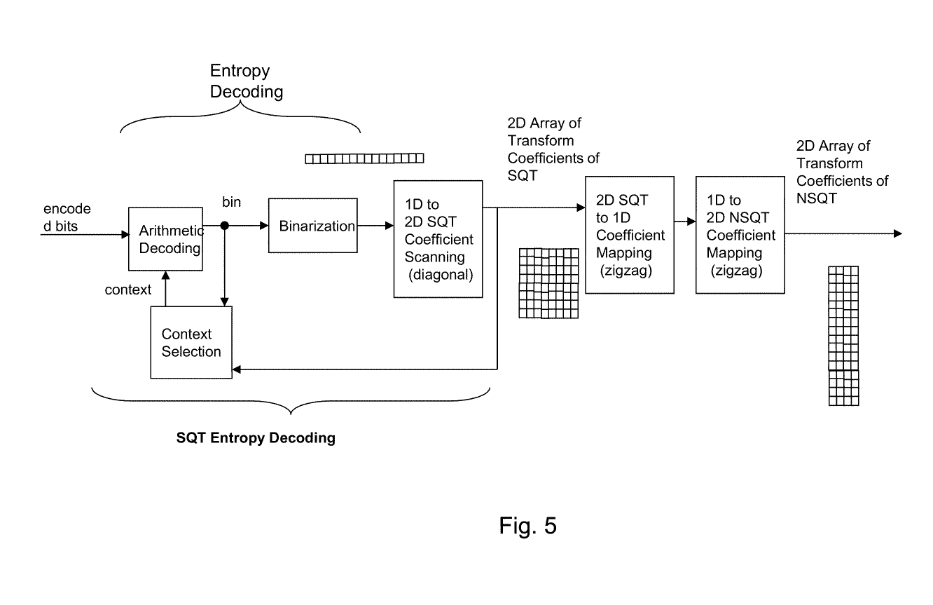

In addition to the typically used square transforms, non-square transforms (NSQT) are specified in, e.g., WD4, for use on non-square residual PUs (i.e., PUs with dimensions 2N×N, 2N×nU, 2N×nD, N×2N, nL×2N or nR×2N). However, the entropy coding of transform coefficients in WD4 is specified such the context selection is based on the positions of the transform coefficients in square transform units. Further, the scan that controls the order in which the transform coefficients are coded in the bit stream is based on the transform unit size, i.e., the scan crosses the entire block. Rather than changing the context selection and scanning to comprehend non-square transforms, the NSQTs are mapped to square arrays of specified sizes using a zigzag scan and the SQT contexts are used to encode the square arrays. As a result, additional processing is needed in an encoder to map a 2D NSQT coefficient array to a square coefficient array of one of the specified SQT block sizes prior to entropy coding (see FIG. 4). Similarly, additional processing is needed in a decoder to map the decoded square 2D transform coefficient array to the 2D non-square transform array after entropy decoding (see FIG. 5). For example, 4×16 and 16×4 NSQT blocks are mapped to an 8×8 square array and are entropy coded as an 8×8 SQT block. In another example, 8×32 and 32×8 NSQT blocks are mapped to a 16×16 square array and are entropy coded as a 16×16 SQT block.

More specifically, as illustrated in FIG. 4, the mapping from a 2D NSQT block to a 2D SQT block in an encoder involves two steps. First, the coefficients of the NSQT block are scanned from the non-square 2D array to a 1D array using a zigzag scan. The 1D array is then scanned to a 2D SQT block of the appropriate size using a zigzag scan. Note that these steps can be in theory combined into one. For entropy encoding, the 2D SQT block is then scanned to a 1D array using a diagonal scan. The context selection for entropy coding of the coefficients depends on the size of the 2D SQT block. For 4×4 and 8×8 SQT blocks, the context selection is based on position (X,Y) within the block. For 16×16 and 32×32 SQT blocks, the context selection is based on the neighboring coefficients thus necessitating that the coefficients be stored in an intermediate square 2D array in order to determine the neighbors before the final stage of arithmetic coding. As illustrated in FIG. 5, the mapping of the quantized coefficients in the decoded 2D SQT block to the 2D NSQT block also involves two steps in which the dequantized coefficients in the 2D SQT block are mapped to a 1D array using a zigzag scan and the dequantized coefficients in the 1D array are then mapped to the 2D NSQT block using a zigzag scan.

The zigzag mapping of the NSQT coefficients to the frequency locations of an SQT block changes the relative positions of the NSQT coefficients. Contexts are assigned to a given coefficient position in the SQT transform. Each context models the probability of a non-zero transform coefficient at a given position. For example, at low frequency positions (e.g., DC), there will be a higher probability that the transform coefficient is non-zero. Using a zigzag scan to map transform coefficients from an NSQT block to a SQT block causes a mismatch in many of the coefficient positions. For example, a coefficient located at low frequency position in an NSQT block may be mapped to a high frequency position in the SQT block. As a result, the context model used for that coefficient will not match the probability characteristics of that coefficient.

In summary, supporting NSQTs introduces additional mapping steps during entropy encoding and entropy decoding which may impact throughput and may increase hardware complexity (increased area cost). Further, the zigzag scanning used for mapping of the quantized transform coefficients of an NSQT block to an SQT block may place many of the coefficients in positions such that there is a mismatch between the expected value of the coefficient and the content model for that position. Embodiments of the invention provide for mapping of NSQT blocks into multiple smaller square blocks rather than into a larger single square block such that there is a better chance that the quantized transform coefficients are mapped to positions that match the context model for that position. In some embodiments, the scan order used for mapping the NSQT blocks to the smaller square blocks is the same as that used for entropy encoding. Further, in some embodiments, the multiple mapping/scanning steps are combined in a single step that is less complex to implement than the prior art multiple steps. Further, in some embodiments, the intermediate 2D array needed for context selection for transform block sizes larger than 8×8 is also eliminated for NSQTs.

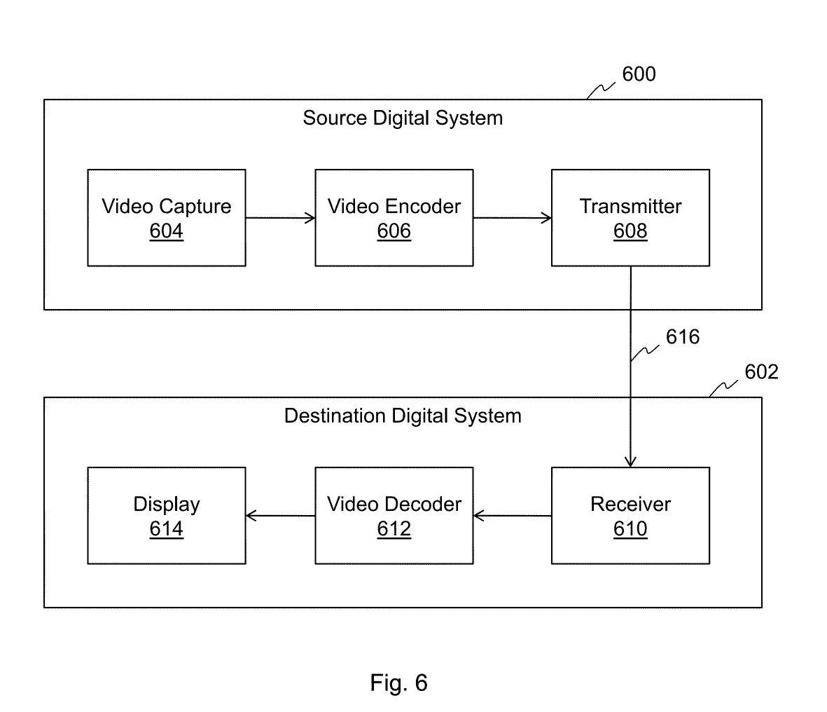

FIG. 6 shows a block diagram of a digital system that includes a source digital system 600 that transmits encoded video sequences to a destination digital system 602 via a communication channel 616. The source digital system 600 includes a video capture component 604, a video encoder component 606, and a transmitter component 608. The video capture component 604 is configured to provide a video sequence to be encoded by the video encoder component 606. The video capture component 604 may be, for example, a video camera, a video archive, or a video feed from a video content provider. In some embodiments, the video capture component 604 may generate computer graphics as the video sequence, or a combination of live video, archived video, and/or computer-generated video.

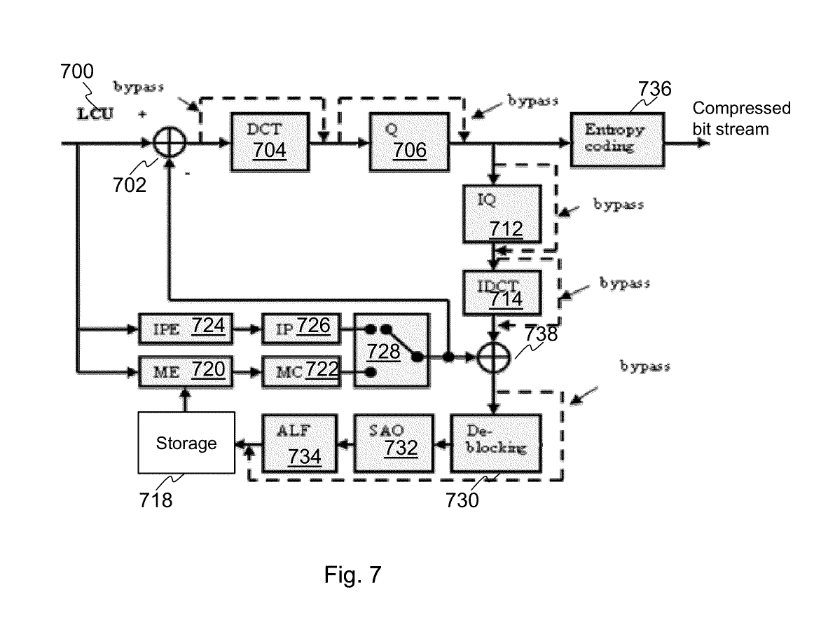

The video encoder component 606 receives a video sequence from the video capture component 604 and encodes it for transmission by the transmitter component 608. The video encoder component 606 receives the video sequence from the video capture component 604 as a sequence of pictures, divides the pictures into largest coding units (LCUs), and encodes the video data in the LCUs. The video encoder component 606 is configured to use non-square transforms for encoding of video data in the video sequence as appropriate during the encoding process. As part of the encoding process, the video encoder component 606 may perform non-square transform scanning as described herein. An embodiment of the video encoder component 606 is described in more detail herein in reference to FIG. 7.

The transmitter component 608 transmits the encoded video data to the destination digital system 602 via the communication channel 616. The communication channel 616 may be any communication medium, or combination of communication media suitable for transmission of the encoded video sequence, such as, for example, wired or wireless communication media, a local area network, or a wide area network.

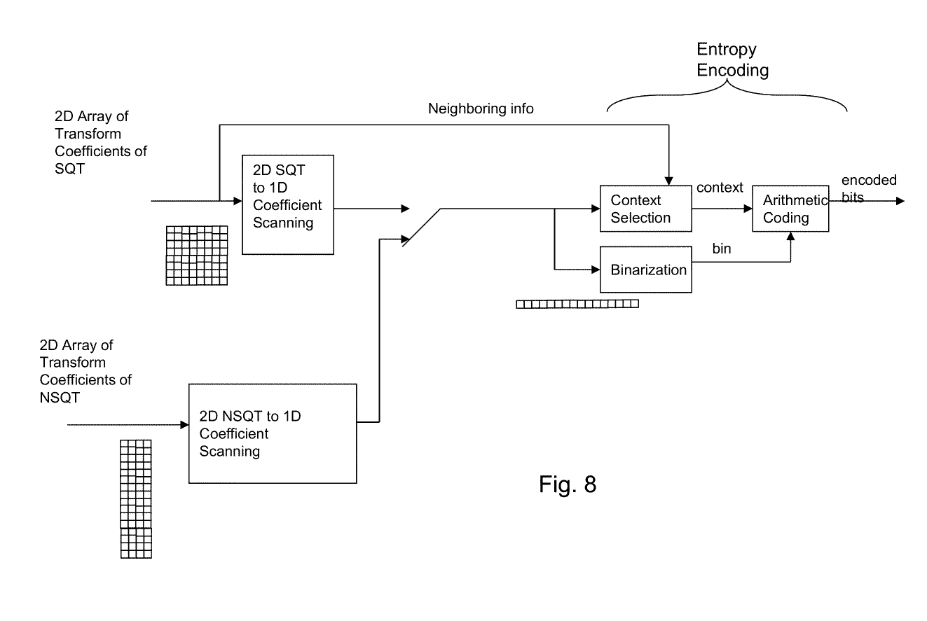

The destination digital system 602 includes a receiver component 610, a video decoder component 612 and a display component 614. The receiver component 610 receives the encoded video data from the source digital system 600 via the communication channel 616 and provides the encoded video data to the video decoder component 612 for decoding. The video decoder component 612 reverses the encoding process performed by the video encoder component 606 to reconstruct the LCUs of the video sequence. The video decoder component 612 is configured to decode video data transformed using non-square transforms during the encoding process as needed during the decoding process. As part of the decoding process, the video decoder component 612 may perform non-square transform scanning as described herein. An embodiment of the video decoder component 612 is described in more detail below in reference to FIG. 8.

The reconstructed video sequence is displayed on the display component 614. The display component 614 may be any suitable display device such as, for example, a plasma display, a liquid crystal display (LCD), a light emitting diode (LED) display, etc.

In some embodiments, the source digital system 600 may also include a receiver component and a video decoder component and/or the destination digital system 602 may include a transmitter component and a video encoder component for transmission of video sequences both directions for video steaming, video broadcasting, and video telephony. Further, the video encoder component 606 and the video decoder component 612 may perform encoding and decoding in accordance with one or more video compression standards. The video encoder component 606 and the video decoder component 612 may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc.

FIG. 7 shows a block diagram of an example video encoder configured to use both square and non-square transform unit (block) sizes as appropriate to encode video data. FIG. 8 shows a block diagram of an example video decoder configured to decode video data encoded using either square or non-square transform units. For simplicity of explanation, the HEVC context definitions of WD4 for square transform blocks are assumed for entropy coding and decoding of transform coefficients. One of ordinary skill in the art, having benefit of this disclosure, will understand that other suitable context definitions may be used.

Referring now to FIG. 7, a block diagram of the LCU processing portion of an example video encoder is shown. A coding control component (not shown) sequences the various operations of the LCU processing, i.e., the coding control component runs the main control loop for video encoding. The coding control component receives a digital video sequence and performs any processing on the input video sequence that is to be done at the picture level, such as determining the coding type (I, P, or B) of a picture based on the high level coding structure, e.g., IPPP, IBBP, hierarchical-B, and dividing a picture into LCUs for further processing.

In addition, for pipelined architectures in which multiple LCUs may be processed concurrently in different components of the LCU processing, the coding control component controls the processing of the LCUs by various components of the LCU processing in a pipeline fashion. For example, in many embedded systems supporting video processing, there may be one master processor and one or more slave processing modules, e.g., hardware accelerators. The master processor operates as the coding control component and runs the main control loop for video encoding, and the slave processing modules are employed to off load certain compute-intensive tasks of video encoding such as motion estimation, motion compensation, intra prediction mode estimation, transformation and quantization, entropy coding, and loop filtering. The slave processing modules are controlled in a pipeline fashion by the master processor such that the slave processing modules operate on different LCUs of a picture at any given time. That is, the slave processing modules are executed in parallel, each processing its respective LCU while data movement from one processor to another is serial.

The LCU processing receives LCUs 700 of the input video sequence from the coding control component and encodes the LCUs 700 under the control of the coding control component to generate the compressed video stream. The LCUs 700 in each picture are processed in row order. The LCUs 700 from the coding control component are provided as one input of a motion estimation component (ME) 720, as one input of an intra-prediction estimation component (IPE) 724, and to a positive input of a combiner 702 (e.g., adder or subtractor or the like). Further, although not specifically shown, the prediction mode of each picture as selected by the coding control component is provided to a mode decision component 728 and the entropy coding component 736.

The storage component 718 provides reference data to the motion estimation component 720 and to the motion compensation component 722. The reference data may include one or more previously encoded and decoded pictures, i.e., reference pictures.

The motion estimation component 720 provides motion data information to the motion compensation component 722 and the entropy coding component 736. More specifically, the motion estimation component 720 performs tests on CUs in an LCU based on multiple inter-prediction modes (e.g., skip mode, merge mode, and normal or direct inter-prediction), PU sizes, and TU sizes using reference picture data from storage 718 to choose the best CU partitioning, PU/TU partitioning, inter-prediction modes, motion vectors, etc. based on coding cost, e.g., a rate distortion coding cost. The PU sizes considered include both square and non-square sizes and the TU sizes considered include both square transforms and non-square transforms. To perform the tests, the motion estimation component 720 may divide an LCU into CUs according to the maximum hierarchical depth of the quadtree, and divide each CU into PUs according to the unit sizes of the inter-prediction modes and into TUs according to the transform unit sizes, and calculate the coding costs for each PU size, prediction mode, and transform unit size for each CU. The motion estimation component 720 provides the motion vector (MV) or vectors and the prediction mode for each PU in the selected CU partitioning to the motion compensation component (MC) 722.

The motion compensation component 722 receives the selected inter-prediction mode and mode-related information from the motion estimation component 720 and generates the inter-predicted CUs. The inter-predicted CUs are provided to the mode decision component 728 along with the selected inter-prediction modes for the inter-predicted PUs and corresponding TU sizes for the selected CU/PU/TU partitioning. The coding costs of the inter-predicted CUs are also provided to the mode decision component 728.

The intra-prediction estimation component 724 (IPE) performs intra-prediction estimation in which tests on CUs in an LCU based on multiple intra-prediction modes, PU sizes, and TU sizes are performed using reconstructed data from previously encoded neighboring CUs stored in a buffer (not shown) to choose the best CU partitioning, PU/TU partitioning, and intra-prediction modes based on coding cost, e.g., a rate distortion coding cost. To perform the tests, the intra-prediction estimation component 724 may divide an LCU into CUs according to the maximum hierarchical depth of the quadtree, and divide each CU into PUs according to the unit sizes of the intra-prediction modes and into TUs according to the transform unit sizes, and calculate the coding costs for each PU size, prediction mode, and transform unit size for each PU. In some embodiments, non-square PUs and non-square transform sizes may be used for intra-predicted CUs. In such embodiments, the PU sizes considered include both square and non-square sizes and the TU sizes considered include both square transforms and non-square transforms. The intra-prediction estimation component 724 provides the selected intra-prediction modes for the PUs, and the corresponding TU sizes for the selected CU partitioning to the intra-prediction component (IP) 726. The coding costs of the intra-predicted CUs are also provided to the intra-prediction component 726.

The intra-prediction component 726 (IP) receives intra-prediction information, e.g., the selected mode or modes for the PU(s), the PU size, etc., from the intra-prediction estimation component 724 and generates the intra-predicted CUs. The intra-predicted CUs are provided to the mode decision component 728 along with the selected intra-prediction modes for the intra-predicted PUs and corresponding TU sizes for the selected CU/PU/TU partitioning. The coding costs of the intra-predicted CUs are also provided to the mode decision component 728.

The mode decision component 728 selects between intra-prediction of a CU and inter-prediction of a CU based on the intra-prediction coding cost of the CU from the intra-prediction component 726, the inter-prediction coding cost of the CU from the motion compensation component 722, and the picture prediction mode provided by the coding control component. Based on the decision as to whether a CU is to be intra- or inter-coded, the intra-predicted PUs or inter-predicted PUs are selected. The selected CU/PU/TU partitioning with corresponding modes and other mode related prediction data (if any) such as motion vector(s) and reference picture index (indices), are provided to the entropy coding component 736.

The output of the mode decision component 728, i.e., the predicted PUs, is provided to a negative input of the combiner 702 and to the combiner 738. The associated transform unit size is also provided to the transform component 704. The combiner 702 subtracts a predicted PU from the original PU. Each resulting residual PU is a set of pixel difference values that quantify differences between pixel values of the original PU and the predicted PU. The residual blocks of all the PUs of a CU form a residual CU for further processing.

The transform component 704 performs block transforms on the residual CUs to convert the residual pixel values to transform coefficients and provides the transform coefficients to a quantize component 706. More specifically, the transform component 704 receives the transform unit sizes for the residual CU and applies transforms of the specified sizes to the CU to generate transform coefficients. Further, the quantize component 706 quantizes the transform coefficients based on quantization parameters (QPs) and quantization matrices provided by the coding control component and the transform sizes and provides the quantized transform coefficients to the entropy coding component 736 for coding in the bit stream.

The entropy coding component 736 entropy encodes the relevant data, i.e., syntax elements, output by the various encoding components and the coding control component using context-adaptive binary arithmetic coding (CABAC) to generate the compressed video bit stream. Among the syntax elements that are encoded are picture parameter sets, flags indicating the CU/PU/TU partitioning of an LCU, the prediction modes for the CUs, and the quantized transform coefficients for the CUs. The entropy coding component 736 also codes relevant data such as ALF parameters, e.g., filter type, on/off flags, and filter coefficients, and SAO parameters, e.g., filter type, on/off flags, and offsets as needed.

FIG. 8 illustrates the CABAC encoding of transform coefficients by the entropy coding component 736 in more detail. For square transform blocks, the entropy coding component 736 scans the 2D square array of quantized transform coefficients to a 1D array according to a scan order selected based on the prediction mode of the CU. For example, if the CU is inter-predicted, a diagonal scan order may be used, and if the CU is intra-predicted, a horizontal or vertical scan order may be used depending on the particular intra-prediction mode. Syntax elements corresponding to the quantized transform coefficients in the 1D array are then entropy coded using CABAC to generate the encoded bits representing the coefficients. The scan orders used are defined by the video coding standard. Accordingly, other suitable scan orders may be used.

In general, for CABAC, a syntax element such as a quantized transform coefficient is binarized to convert it into a binary code. A context model storing the probability of a bin being 0 or 1 is selected from a set of context models for one or more bins depending on the statistics of the recently-code syntax elements. An arithmetic coder encodes each bin according to the selected context model to generate the encoded bits and the context model is updated based on the actual coded value. The particular syntax elements, binarization, and context models used are defined by the video coding standard. Examples of suitable syntax elements, binarization, and context models for entropy encoding of transform coefficients may be found, for example, in WD4. The context model selection for transform coefficient related syntax elements is defined assuming a particular scan order for transform coefficients. Further, the particular scan order assumed depends on the prediction of the CU. The scan order used to scan the 2D square array to the 1D array should be the same as this assumed scan order to avoid additional processing overhead.

In WD4 (and later drafts), the selection of context models for transform coefficient related syntax elements depends on neighboring coefficient values in the square transform block for transform blocks larger than 8×8. For 4×4 and 8×8 SQT blocks, the context model is selected based on position (X,Y) within the transform block.

For non-square transform blocks, the entropy coding component. 736 maps the quantized transform coefficients in the 2D NSQT block to some number of smaller equal-sized square 2D arrays, and then scans these smaller square arrays to a 1D array for entropy coding. As is explained in more detail herein, the mapping and scanning may be combined into a single step. The same scan order is used to map the NSQT block to the smaller square arrays and to scan the smaller square arrays to the 1D array. The size of the smaller square arrays corresponds to the size of an SQT block. In embodiments in which NSQTs are not supported for intra-prediction, the scan order used is the same as that assumed for entropy coding, e.g., diagonal.

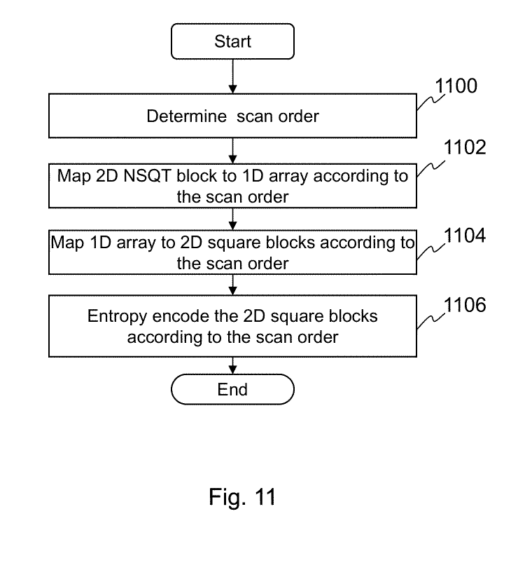

In embodiments in which NSQTs are supported for both inter-prediction and intra-prediction, the scan order is selected based on the prediction mode of the CU. For example, if the CU is inter-predicted, a diagonal scan order may be used, and if the CU is intra-predicted, a horizontal or vertical scan order may be used depending on the particular intra-prediction mode. The scanning of the quantized transform coefficients of an NSQT block to a 1D array is described in more detail herein in reference to the method of FIG. 11.

Syntax elements corresponding to the quantized transform coefficients in the 1D array are then entropy coded using CABAC to generate the encoded bits representing the coefficients. For the entropy coding, the syntax elements for the coefficients of each of the square arrays are encoded in the same way an SQT block of the same size would be entropy encoded. In other words, each smaller square block is entropy coded as an SQT block of the same size, using the context model selection criteria for the SQT block. For example, a 4×4 block is encoded as a 4×4 SQT and an 8×8 block is encoded as an 8×8 SQT.

Referring again to FIG. 7, the LCU processing component 742 includes an embedded decoder. As any compliant decoder is expected to reconstruct an image from a compressed bit stream, the embedded decoder provides the same utility to the video encoder. Knowledge of the reconstructed input allows the video encoder to transmit the appropriate residual energy to compose subsequent pictures.

The quantized transform coefficients for each CU are provided to an inverse quantize component (IQ) 712, which outputs a reconstructed version of the transform result from the transform component 704. The dequantized transform coefficients are provided to the inverse transform component (IDCT) 714, which outputs estimated residual information representing a reconstructed version of a residual CU. The inverse transform component 714 receives the transform unit size used to generate the transform coefficients and applies inverse transform(s) of the specified size to the transform coefficients to reconstruct the residual values. The reconstructed residual CU is provided to the combiner 738.

The combiner 738 adds the original predicted CU to the residual CU to generate a reconstructed CU, which becomes part of reconstructed picture data. The reconstructed picture data is stored in a buffer (not shown) for use by the intra-prediction estimation component 724.

Various in-loop filters may be applied to the reconstructed picture data to improve the quality of the reference picture data used for encoding/decoding of subsequent pictures. The in-loop filters may include a deblocking filter 730, a sample adaptive offset filter (SAO) 732, and an adaptive loop filter (ALF) 734. In some embodiments, the ALF 734 may not be present. The in-loop filters 730, 732, 734 are applied to each reconstructed LCU in the picture and the final filtered reference picture data is provided to the storage component 718.

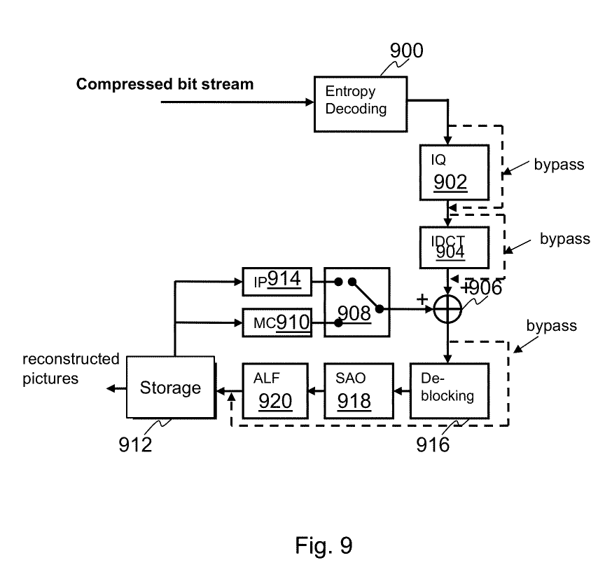

Referring now to the example video decoder of FIG. 9, the entropy decoding component 900 receives an entropy encoded (compressed) video bit stream and reverses the entropy encoding using CABAC decoding to recover the encoded syntax elements, e.g., CU, PU, and TU structures of LCUs, quantized transform coefficients for CUs, motion vectors, prediction modes, etc. The decoded syntax elements are passed to the various components of the decoder as needed. For example, decoded prediction modes are provided to the intra-prediction component (IP) 914 or motion compensation component (MC) 910. If the decoded prediction mode is an inter-prediction mode, the entropy decoder 900 reconstructs the motion vector(s) as needed and provides the motion vector(s) to the motion compensation component 910.

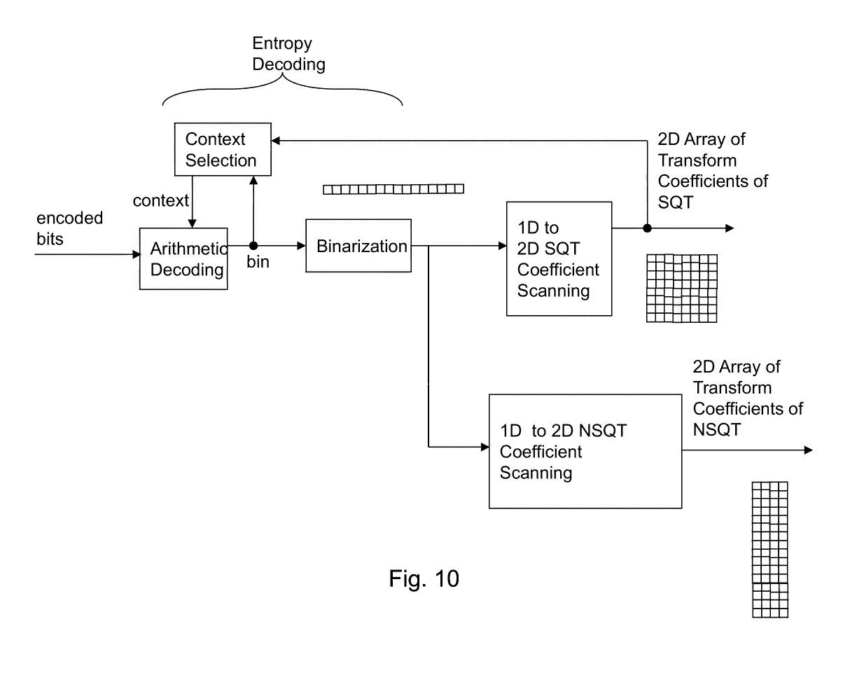

FIG. 10 illustrates the CABAC decoding of quantized transform coefficients by the entropy decoding component 900 in more detail. The CABAC decoding reverses the CABAC encoding, performing arithmetic decoding on the bit stream according to selected context models to recover the encoded bins and debinarizing the bins to recover the syntax elements. Syntax elements corresponding to quantized transform coefficients are entropy decoded from the compressed bit stream and the quantized transform coefficients are output as a 1D array. The context models, context model selection criteria, and binarization are the same as that used in the encoder. If the quantized transform coefficients correspond to an SQT block, the 1D array of decoded quantized transform coefficients is scanned into the SQT block for further processing in the decoder. The scan order used is the same as that assumed by CABAC and is the same as that used in the encoder to scan the SQT block to a 1D array for entropy encoding. The scan order is selected based on the prediction mode of the CU containing the SQT block.

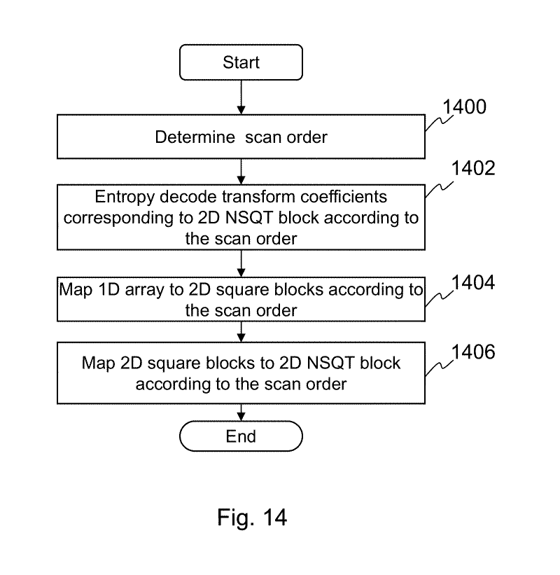

If the quantized transform coefficients correspond to an NSQT block, the 1D array of decoded quantized transform coefficients is mapped into the same number of smaller square 2D arrays as used for entropy encoding of the NSQT block. The quantized transform coefficients in these 2D arrays are then scanned into the NSQT block for further processing by the decoder. As is explained in more detail herein, the mapping and scanning may be combined into a single step. The scan order used for the mapping of the 1D array and the scanning of the 2D arrays is the same as that assumed by CABAC and is the same as the scan order used in the encoder to map the NSQT block to the square arrays and scan the square arrays to the 1D array for entropy encoding. The scan order is selected based on the prediction mode of the CU containing the SQT block. The scanning of the 1D array to the NSQT block is described in more detail herein in reference to the method of FIG. 14.

The inverse quantize component (IQ) 902 de-quantizes the quantized transform coefficients of the CUs. The inverse transform component 904 transforms the frequency domain data from the inverse quantize component 902 back to the residual CUs. That is, the inverse transform component 904 applies an inverse unit transform, i.e., the inverse of the unit transform used for encoding, to the de-quantized residual coefficients to produce reconstructed residual values of the CUs.

A residual CU supplies one input of the addition component 906. The other input of the addition component 906 comes from the mode switch 908. When an inter-prediction mode is signaled in the encoded video stream, the mode switch 908 selects predicted PUs from the motion compensation component 910 and when an intra-prediction mode is signaled, the mode switch selects predicted PUs from the intra-prediction component 914.

The motion compensation component 910 receives reference data from the storage component 912 and applies the motion compensation computed by the encoder and transmitted in the encoded video bit stream to the reference data to generate a predicted PU. That is, the motion compensation component 910 uses the motion vector(s) from the entropy decoder 900 and the reference data to generate a predicted PU.

The intra-prediction component 914 receives reconstructed samples from previously reconstructed PUs of a current picture from the storage component 912 and performs the intra-prediction computed by the encoder as signaled by an intra-prediction mode transmitted in the encoded video bit stream using the reconstructed samples as needed to generate a predicted PU.

The addition component 906 generates a reconstructed CU by adding the predicted PUs selected by the mode switch 908 and the residual CU. The output of the addition component 906, i.e., the reconstructed CUs, is stored in the storage component 912 for use by the intra-prediction component 914.

In-loop filters may be applied to reconstructed picture data to improve the quality of the decoded pictures and the quality of the reference picture data used for decoding of subsequent pictures. The in-loop filters are the same as those of the encoder, i.e., a deblocking filter 916, a sample adaptive offset filter (SAO) 918, and an adaptive loop filter (ALF) 920. In some embodiments, the ALF 920 may not be present. The in-loop filters may be applied on an LCU-by-LCU basis and the final filtered reference picture data is provided to the storage component 912.

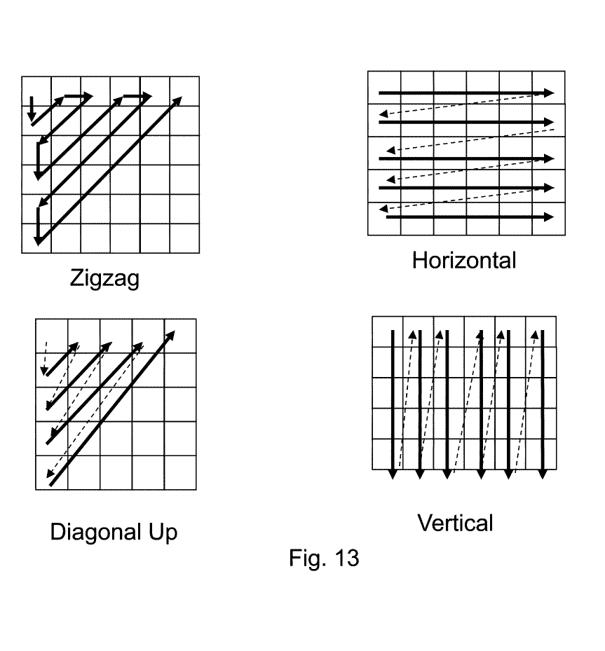

FIG. 11 is a flow diagram of a method for scanning an NSQT block of quantized transform coefficients into a 1D array for entropy coding. Initially, the scan order to be used is determined 1100. In some embodiments, NSQTs are not supported for intra-predicted CUs. In such embodiments, the scan order used is the same scan order is that is assumed for entropy encoding, e.g., diagonal. In some embodiments, NSQTs are supported for both intra-predicted and inter-predicted CUS. In such embodiments, the scan order used may be dependent on the prediction mode of the CU corresponding to the NSQT block. In some such embodiments, a diagonal scan order is used for inter-predicted CUs and a vertical or horizontal scan order is used for intra-predicted CUs depending on the particular intra-prediction mode. Examples of scan orders used for particular intra-prediction modes may be found, e.g., in WD4 (and later drafts). The particular scan order to be used is defined by the video coding standard. Accordingly, other suitable scan orders may be used. FIG. 13 illustrates zigzag, horizontal, diagonal up, and vertical scan orders.

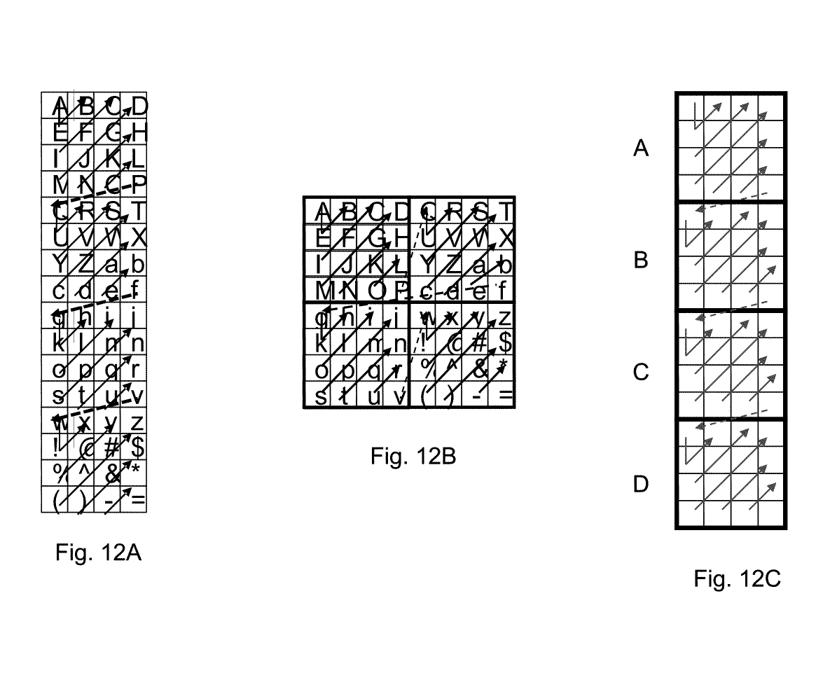

The quantized transform coefficients of the 2D NSQT block are then mapped 1102 to a 1D array according to the scan order to reorder the coefficients and the 1D array is mapped 1104 to 2D square blocks smaller than the NSQT block according to the scan order. The size and number of 2D square blocks used depends on the size of the 2D NSQT block. For example, a 4×8 or 8×4 NSQT block may be mapped to two 4×4 arrays, a 4×16 or 16×4 NSQT block may be mapped to four 4×4 arrays or an 8×8 array, and an 8×32 or 32×8 NSQT block may be mapped to four 8×8 arrays or sixteen 4×4 arrays. Larger NSQT blocks may be similarly mapped into the appropriate number of 8×8 or 4×4 arrays. The actual mapping of each NSQT block to smaller square blocks may be specified the video coding standard. FIG. 12A shows an example of mapping a 4×16 NSQT block to four 4×4 square blocks using a diagonal scan order. FIG. 12B show an example of mapping a 4×16 NSQT block to an 8×8 square block using a diagonal scan order. Note that using these square array sizes allows the use of the corresponding 4×4 and 8×8 SQT context selection. Because this context selection does not use information regarding neighboring coefficients, the intermediate 2D square array shown in FIG. 4 can be bypassed.

Referring again to FIG. 11, the 2D square blocks are entropy encoded 1106 according to the scan order. More specifically, for entropy coding, each square block is coded as an SQT block of the same size. Further, the quantized transform coefficients in each square block are scanned into a 1D array for the entropy coding according to the scan order. FIG. 12C illustrates the order of the quantized transform coefficients in the 1D array for four 4×4 blocks with diagonal scanning.

In some embodiments, the mapping steps 1102 and 1104, and the scanning to a 1D array for entropy encoding of step 1106 may be combined. That is, rather than mapping the NSQT block to smaller square blocks prior to scanning to 1D for entropy coding, the NSQT block is directly scanned to 1D for entropy coding according to the size of the smaller blocks. For example, as illustrated in FIG. 12C, for 4×16 or 16×4 NSQT blocks, the NSQT block can be diagonally scanned as shown, where the quantized transform coefficients of the logical 4×4 square block A are diagonally scanned to 1D as shown, followed by the quantized transform coefficients of the logical 4×4 square block B, etc.

The processing of the NSQT coefficients in a sub-block order, i.e., the mapping of the coefficients to multiple smaller square arrays, is an improvement over the prior art for several reasons. Using the same scan order for the mapping/scanning simplifies the implementation as there is no need to map from one scan order to another as in the prior art. In addition, there are fewer mismatches between the probability characteristics of mapped NSQT coefficients and the contexts used to encode them as the relative positions of the coefficients are not changed. In the prior art, the use of the zigzag scan significantly changes the order of the coefficients such that low frequency and high frequency coefficients can end up next to each other. Further, mapping the NSQT blocks to smaller square arrays such as 4×4 and 8×8 allows the smaller arrays to be coded as 4×4 or 8×8 SQTs which have no neighboring dependencies for context selection.

FIG. 14 is a flow diagram of a method for scanning a 1D array of entropy decoded transform coefficients corresponding to an NSQT block to recreate the NSQT block. Initially, the scan order to be used is determined 1400. In general, the scan order is the inverse of the scan order used in the encoder. In some embodiments, NSQTs are not supported for intra-predicted CUs. In such embodiments, the scan order used is the inverse of the scan order used for entropy encoding, e.g., inverse diagonal. In some embodiments, NSQTs are supported for both intra-predicted and inter-predicted CUS. In such embodiments, the scan order used may be dependent on the prediction mode of the CU corresponding to the NSQT block. Thus, the scan order may be determined from the decoded prediction mode for the CU corresponding to the NSQT block. In some such embodiments, a diagonal scan order is used for entropy coding of inter-predicted CUs and a vertical or horizontal scan order is used for entropy coding of intra-predicted CUs depending on the particular intra-prediction mode. Other suitable scan orders may also be used.

The quantized transform coefficients corresponding to the 2D NSQT block are then entropy decoded 1402 according to the scan order to generate a 1D array of quantized transform coefficients. That is, the quantized transform coefficients of each of the square blocks corresponding the 2D NSQT block are decoded according to context selection for an SQT block of the same size.

The 1D array of decoded quantized transform coefficients is then mapped 1404 to the square blocks according to the scan order, thus recreating the square blocks of quantized transform coefficients that were encoded. The quantized coefficients in the 2D square blocks are then mapped 1406 to the 2D NSQT block according to the scan order, thus recreating the 2D NSQT block that was encoded.

In some embodiments, the mapping steps 1404 and 1406 may be combined. That is, rather than mapping 1D array of decoded quantized transform coefficients to the square blocks and then mapping the coefficients in the square block to the NSQT, the coefficients in the 1D array are directly mapped to the NSQT block according to the size of the smaller blocks and the scan order. Referring to the example of in FIG. 12C, for 4×16 or 16×4 NSQT blocks, the quantized transform coefficients of the logical 4×4 square block A are decoded first and can be directly mapped into the corresponding positions of the NSQT block according to the diagonal scan. The quantized transform coefficients of the logical 4×4 square block B are then decoded and can be directly mapped in the corresponding position of the NSQT block according to the diagonal scan. The quantized transform coefficients of the logical 4×4 square blocks C and D are similarly decoded and mapped.

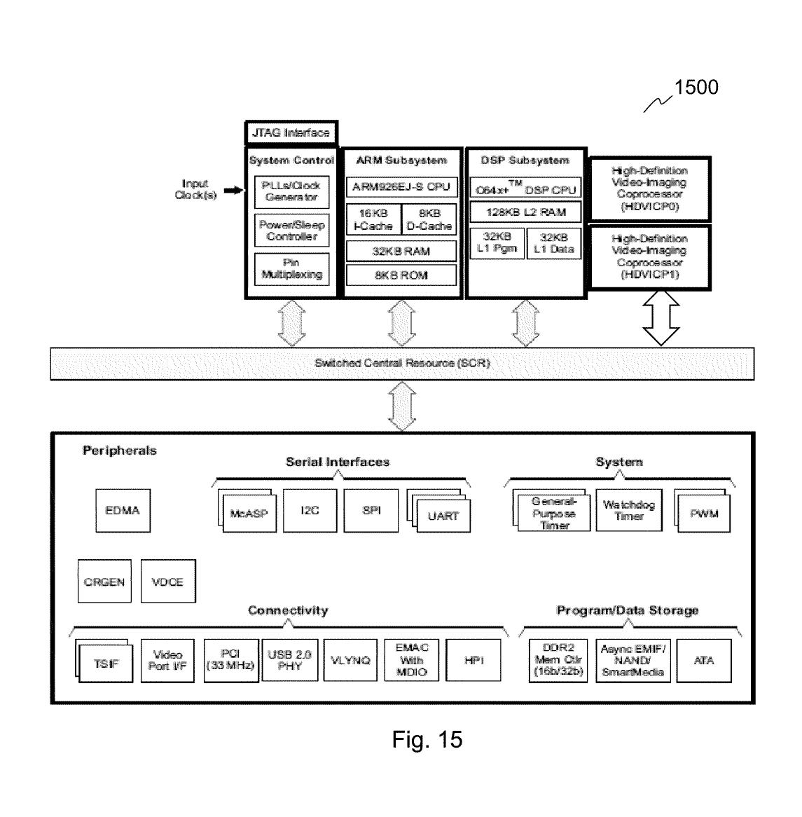

FIG. 15 is a block diagram of an example digital system suitable for use as an embedded system that may be configured to encode a video sequence using non-square transforms and/or to decode a compressed video bit stream encoded using non-square transforms as described herein. This example system-on-a-chip (SoC) is representative of one of a family of DaVinci™ Digital Media Processors, available from Texas Instruments, Inc. This SoC is described in more detail in “TMS320DM6467 Digital Media System-on-Chip”, SPRS403G, December 2007 or later, which is incorporated by reference herein.

The SoC 1500 is a programmable platform designed to meet the processing needs of applications such as video encode/decode/transcode/transrate, video surveillance, video conferencing, set-top box, medical imaging, media server, gaming, digital signage, etc. The SoC 1500 provides support for multiple operating systems, multiple user interfaces, and high processing performance through the flexibility of a fully integrated mixed processor solution. The device combines multiple processing cores with shared memory for programmable video and audio processing with a highly-integrated peripheral set on common integrated substrate.

The dual-core architecture of the SoC 1500 provides benefits of both DSP and Reduced Instruction Set Computer (RISC) technologies, incorporating a DSP core and an ARM926EJ-S core. The ARM926EJ-S is a 32-bit RISC processor core that performs 32-bit or 16-bit instructions and processes 32-bit, 16-bit, or 8-bit data. The DSP core is a TMS320C64x+TM core with a very-long-instruction-word (VLIW) architecture. In general, the ARM is responsible for configuration and control of the SoC 1500, including the DSP Subsystem, the video data conversion engine (VDCE), and a majority of the peripherals and external memories. The switched central resource (SCR) is an interconnect system that provides low-latency connectivity between master peripherals and slave peripherals. The SCR is the decoding, routing, and arbitration logic that enables the connection between multiple masters and slaves that are connected to it.

The SoC 1500 also includes application-specific hardware logic, on-chip memory, and additional on-chip peripherals. The peripheral set includes: a configurable video port (Video Port I/F), an Ethernet MAC (EMAC) with a Management Data Input/Output (MDIO) module, a 4-bit transfer/4-bit receive VLYNQ interface, an inter-integrated circuit (I2C) bus interface, multichannel audio serial ports (McASP), general-purpose timers, a watchdog timer, a configurable host port interface (HPI); general-purpose input/output (GPIO) with programmable interrupt/event generation modes, multiplexed with other peripherals, UART interfaces with modem interface signals, pulse width modulators (PWM), an ATA interface, a peripheral component interface (PCI), and external memory interfaces (EMIFA, DDR2). The video port I/F is a receiver and transmitter of video data with two input channels and two output channels that may be configured for standard definition television (SDTV) video data, high definition television (HDTV) video data, and raw video data capture.

As shown in FIG. 15, the SoC 1500 includes two high-definition video/imaging coprocessors (HDV/CP) and a video data conversion engine (VDCE) to offload many video and image processing tasks from the DSP core. The VDCE supports video frame resizing, anti-aliasing, chrominance signal format conversion, edge padding, color blending, etc. The HDVICP coprocessors are designed to perform computational operations required for video encoding and/or decoding such as motion estimation, motion compensation, intra-prediction, transformation, inverse transformation, quantization, and inverse quantization. Further, the distinct circuitry in the HDVICP coprocessors that may be used for specific computation operations is designed to operate in a pipeline fashion under the control of the ARM subsystem and/or the DSP subsystem.

### Other Embodiments

While the invention has been described with respect to a limited number of embodiments, those skilled in the art, having benefit of this disclosure, will appreciate that other embodiments can be devised which do not depart from the scope of the invention as disclosed herein.

For example, embodiments have been described herein assuming the use of CABAC for entropy encoding and decoding. One of ordinary skill in the art will understand embodiments in which context-adaptive variable-length coding (CAVLC) is used.

Embodiments of the methods, encoders, and decoders described herein may be implemented in hardware, software, firmware, or any combination thereof. If completely or partially implemented in software, the software may be executed in one or more processors, such as a microprocessor, application specific integrated circuit (ASIC), field programmable gate array (FPGA), or digital signal processor (DSP). The software instructions may be initially stored in a computer-readable medium and loaded and executed in the processor. In some cases, the software instructions may also be sold in a computer program product, which includes the computer-readable medium and packaging materials for the computer-readable medium. In some cases, the software instructions may be distributed via removable computer readable media, via a transmission path from computer readable media on another digital system, etc. Examples of computer-readable media include non-writable storage media such as read-only memory devices, writable storage media such as disks, flash memory, memory, or a combination thereof.

Although method steps may be presented and described herein in a sequential fashion, one or more of the steps shown in the figures and described herein may be performed concurrently, may be combined, and/or may be performed in a different order than the order shown in the figures and/or described herein. Accordingly, embodiments should not be considered limited to the specific ordering of steps shown in the figures and/or described herein.

It is therefore contemplated that the appended claims will cover any such modifications of the embodiments as fall within the true scope of the invention.

What is claimed is:

1. A method for encoding a video sequence, the method comprising:
applying a non-square transform to a non-square block of residual values to generate a non-square block of transform coefficients;
quantizing the transform coefficients to generate a non-square block of quantized transform coefficients;
dividing the non-square block of quantized transform coefficients into a plurality of square blocks of quantized transform coefficients; and
entropy encoding the plurality of square coefficient blocks.

2. The method of claim 1, wherein dividing the non-square block comprises mapping the quantized transform coefficients into the plurality of square blocks according to a scan order to be used for entropy encoding of the plurality of square blocks.

3. The method of claim 2, further comprising:
determining the scan order based on a prediction mode used to generate the non-square block of residual values.

4. The method of claim 3, wherein the prediction mode is an intra-prediction mode.

5. The method of claim 2, wherein the scan order is one selected from a group consisting of a diagonal scan, a vertical scan, a horizontal scan, and a zigzag scan.

6. The method of claim 1, wherein entropy encoding comprises entropy encoding the quantized transform coefficients in each of the square blocks according to contexts defined for entropy encoding of N×N blocks of quantized transform coefficients generated by applying an N×N transform to an N×N block of residual values, wherein a size of the square blocks is N×N.

7. The method of claim 1, wherein a size of each of the plurality of square blocks is 4×4.

8. The method of claim 7, wherein entropy encoding comprises entropy encoding each of the square blocks according to contexts defined for entropy encoding of 4×4 blocks of quantized transform coefficients generated by applying a 4×4 transform to a 4×4 block of residual values.

9. The method of claim 1, wherein a size of each of the plurality of square blocks is 8×8.

10. A method for decoding a compressed video bit stream, the method comprising:
entropy decoding a plurality of quantized transform coefficients corresponding to an encoded non-square block of quantized transform coefficients;
mapping the quantized transform coefficients to a plurality of square blocks;
mapping the quantized transform coefficients in the plurality of square blocks to a non-square block to recreate the non-square block of quantized transform coefficients;
dequantizing the quantized transform coefficients to generate a non-square block of transform coefficients; and
applying an inverse non-square transform to the non-square block of transform coefficients to generate a non-square block of residual values.

11. The method of claim 10, wherein mapping the quantized transform coefficients to a plurality of square blocks comprises mapping the quantized transform coefficients into the plurality of square blocks according to a scan order assumed for entropy decoding of the plurality of quantized transform coefficients.

12. The method of claim 11, further comprising:
determining the scan order based on a prediction mode used to encoded a coding block corresponding to the non-square block of quantized transform coefficients.

13. The method of claim 12, wherein the prediction mode is an intra-prediction mode.

14. The method of claim 11, wherein the scan order is one selected from a group consisting of a diagonal scan, a vertical scan, a horizontal scan, and a zigzag scan.

15. The method of claim 10, wherein entropy decoding comprises entropy decoding the quantized transform coefficients corresponding to each of the square blocks according to contexts defined for entropy decoding of N×N blocks of quantized transform coefficients generated by applying an N×N transform to an N×N block of residual values, wherein a size of the square blocks is N×N.

16. The method of claim 10, wherein a size of each of the plurality of square blocks is 4×4.

17. The method of claim 16, wherein entropy decoding comprises entropy decoding the quantized transform coefficients corresponding to each of the square blocks according to contexts defined for entropy decoding of 4×4 blocks of quantized transform coefficients generated by applying a 4×4 transform to a 4×4 block of residual values.

18. The method of claim 1, wherein a size of each of the plurality of square blocks is 8×8.
